(19) United States
(12) Patent Application Publication
(10) Pub. No.: US 2007/0261508 A1
(43) Pub. Date: Nov. 15, 2007

(54) Ergonomic Shifter for a Bicycle

(76) Inventor: Steven D. Acenbrak, Roswell, GA (US)

Correspondence Address: NEEDLE & ROSENBERG, P.C., SUITE 1000, 999 PEACHTREE STREET, ATLANTA, GA, 30309-3915, US

(21) Appl. No.: 11/666,711

(22) PCT Filed: Oct. 31, 2005
(86) PCT No.: PCT/US05/39059

§ 371 Date: Apr. 30, 2007

Related U.S. Application Data
(60) Provisional application No. 60/623,620, filed on Oct. 30, 2004.

(51) Int. Cl. F16C 1/10

(52) U.S. Cl. 74/502.2

(57) ABSTRACT

A shifter for a bicycle having a derailleur, comprising a housing adapted to mount to a handlebar of the bicycle. The shifter further comprising a gear connected with a cable in communication with the derailleur, which is rotatably mounted in the cavity and has first and second sets of teeth; a first pawl element biased by a first biasing member into engagement with the first set of teeth; a second pawl element biased by a second biasing member into engagement with the second set of teeth. The shifter further comprising first and second shifting levers that are movable along a parallel axis of movement with a person's thumb during a shifting operation, such that the first shifting lever moves in a natural direction of movement of the thumb to wind the gear against the resistance of a gear biasing member and advance the gear of the derailleur, and such that the second shifting lever moves along a rotational axis relative to the first lever to release the gear and lower the gear of the derailleur

### CROSS REFERENCE TO RELATED APPLICATION

This application claims priority to U.S. Provisional Patent Application Ser. No. 60/623,620, filed Oct. 30, 2004, which is hereby incorporated by reference in its entirety.

### FIELD OF THE INVENTION

The present invention relates generally to bicycle shifters, and more particularly, is directed to a shifter for a bicycle using at least one lever that moves in the same motion as the natural movement of the thumb while allowing riders to maintain a safe and mechanically efficient grip.

### BACKGROUND

Conventionally, bicycle shifters are mounted to portions of the handlebar of a bicycle. In use, the position or activation of the shift levers typically require the rider to move hands or fingers from a desired position on the handlebar to shift. This severely reduces the rider's grip, which dangerously reduces the rider's ability to balance the bike. This danger increases in competitive situations where riders travel on specialized bikes at high speeds, sometimes over hilly or technically difficult courses. Some of these specialized bicycles, such as time-trial and triathlon bicycles, have specialized handlebars specifically designed for speed in these situations. Shifting gears on these bicycles while riding at high speed for extended periods of time can be hazardous, especially when the shifter is located at a separate and spaced location from the desired position on the handlebar.

Related to this problem is the fact that actuation of conventional shifters, which are typically located at a separate and spaced location from the desired position on the handlebar that most effectively allows the rider to efficiently maximize the transmission of force onto the pedals of the bicycle, forces the rider to momentarily remove his hand from the desired position on the handlebar. This causes a reduction in the effectiveness of the rider's stroke, which causes a loss of efficiency that can translate into a loss of time in a time-trail race. The most effective riding positions are the ones that allow the rider to efficiently maximize the transmission of force to the pedals of the bicycle for prolonged periods of time. Biomechanical efficiency is a significant competitive advantage in these situations. Thus, riders that can shift gears efficiently, especially on hilly or technical courses without moving the hands or sitting down, have a marked competitive advantage. This situation is also safer and more comfortable over a wide variety of riding situations.

It is therefore desirable to maintain a tight grasp with the hand of the rider at the desired location on the handlebars at all times, without needing to undesirably move the rider's hand to steer, brake, accelerate or shift gears.

Finally, many conventional shifters require the use of the index finger to actuate the shifter. This, however, is the same finger used to actuate the brake lever, which is disadvantageous. Further, using an index finger to shift reduces the ability of the rider to actively “pull” with his hands at the desired location during the power stroke transmission, which further reduces the efficiency of the rider.

### SUMMARY OF THE INVENTION

Accordingly, it is an object of the present invention to provide a shifter that overcomes the problems with the aforementioned prior art.

It is another object of the present invention to provide a shifter in which there is minimal to no repositioning of the hands required to actuate the shift levers so that the palm and fingers remain wrapped around the handlebar, substantially in contact therewith at all times.

It is still another object of the present invention to provide a shifter in which the movement of the shifting levers coincides with the natural movement of the thumb such that the grip can be maintained.

It is a still further object of the present invention to provide a shifter in which the thumb can actuate the shifting levers without any restriction from other components of the bicycle.

It is a yet further object of the present invention to provide a shifter in which the index finger is not used to shift.

It is another object of the present invention to provide a shifter which can provide at least one gear stage shift during one entire movement.

It is still another object of the present invention to provide a shifter having a first shifting lever for up-shifting and a second shifting lever positioned adjacent the first shifting lever, that is also actuated by the thumb, for down-shifting.

In accordance with an aspect of the present invention, the present invention is directed to an ergonomic shifter for a bicycle having a drive train and a longitudinal axis. The housing is adapted to mount to a handlebar of the bicycle at a desired location and in a desired position with respect to the handlebar. The handlebar can be, for example and not meant to be limiting, a cow-horn type handlebar, an aero-bar type handle bar, and the like. The shifter is positioned remotely from the drive train.

The shifter further comprises a gear assembly housed within a cavity defined within the housing for controlling actuation of the drive train, a first shifting lever, and a second shifting lever. In one aspect, the first shifting lever is mounted to the housing for rotation relative to the housing. The first shifting lever has a distal end that is adapted to be engaged by a thumb of a person to effect the rotation of the first shifting lever. In use, the first shifting lever is operatively coupled with the gear assembly to activate the gear assembly to control actuation of the drive train in a first direction. In another aspect, the second shifting lever is mounted to the first shifting lever for rotation relative to the first shifting lever. The second shifting lever has a distal end adapted to be engaged by a thumb of a person to effect the rotation of the second shifting lever. The second shifting lever is operatively coupled with the gear assembly to activate the gear assembly to control actuation of the drive train in a second direction, which is opposite to the first direction.

In one aspect, the housing is mounted to the handlebar so as to position the first and second shifting levers relative to the handlebar such that the distal ends of the respective first and second shifting levers are positioned intermediate the handlebar and the longitudinal axis of the bicycle. In use, the first and second shifting levers are adapted to pivot with the thumb of the person during a shifting operation with the person holding onto the handlebar. In this aspect, during the shifting operation, the grip of the person remains taught or is tightened on the handlebar on which the shifter is mounted. On a further aspect, the first and second shifting levers are adapted to move on or parallel to a movement plane that is substantially parallel to a line bisecting the handlebar on which the shifter is mounted.

Additional aspects of the invention will be set forth in part in the description which follows, and in part will be obvious from the description, or may be learned by practice of the invention. Additional aspects of the invention, aside from those disclosed herein, will be realized and attained by means of the elements and combinations particularly pointed out in the appended claims. It is to be understood that both the foregoing general description and the following detailed description and figures are exemplary and explanatory only and are not restrictive of the invention, as claimed.

### BRIEF DESCRIPTION OF THE FIGURES

The accompanying drawings, which are incorporated in and constitute a part of this specification, illustrate several embodiments of the invention and together with the description, serve to explain the principles of the invention.

FIG. 1A is a side elevational view of one embodiment of a right hand shifter according to the present invention, showing the shifter mounted thereon a portion of a handlebar.

FIG. 1B is a rear elevational view of the shifter of FIG. 1A.

FIG. 1C is a bottom plan view of the shifter of FIG. 1A.

FIG. 2 is a partial perspective exploded view of the shifter of FIG. 1A.

FIG. 3 is an opposite side partial perspective exploded view of the shifter of FIG. 1A.

FIGS. 4A and 4B are perspective views of a housing of the shifter.

FIG. 5A is a perspective view of a mounting member adapted to connect the housing to the mounting member at a desired angle such that the housing can be positioned relative to the handlebar.

FIG. 5B is a side elevational view of the mounting member of FIG. 5A.

FIG. 6A is a perspective view of one embodiment of the gear of the shifter for use in a right hand shifter for shifting gears in a rear derailleur.

FIG. 6B is a top plan view of the gear of FIG. 6A.

FIG. 6C is a side elevational view of the gear of FIG. 6A.

FIG. 7A is a perspective view of one embodiment of the gear of the shifter for use in a right hand shifter for shifting gears in a rear derailleur, showing an extended mount post that comprises a portion of the shift indicator subassembly.

FIG. 7B is a top plan view of the gear of FIG. 7A.

FIG. 7C is a side elevational view of the gear of FIG. 7A.

FIG. 8A is a perspective view of one embodiment of the gear of the shifter for use in a left hand shifter for shifting gears in a front derailleur.

FIG. 8B is a top plan view of the gear of FIG. 8A.

FIG. 8C is a side elevational view of the gear of FIG. 8A.

FIG. 9A is a right front perspective view of one embodiment of the second shift lever of the present invention.

FIG. 9B is a right side elevational view of the second shifting lever of FIG. 9A.

FIG. 9C is a left side perspective view of the second shifting lever of FIG. 9A.

FIG. 9D is a side elevational view of the second shifter lever of FIG. 9A.

FIG. 10A is a side elevational view of one embodiment of the first shifting lever of the present invention.

FIG. 10B is a left side perspective view of the first shifting lever of FIG. 10A.

FIG. 10C is a right side perspective view of the first shifting lever of FIG. 10A, showing the second shifter lever for dimensional comparison.

FIG. 11A is a right side perspective view of one embodiment of the first pawl of the present invention.

FIG. 11B is a left side perspective view of the first pawl of FIG. 11A.

FIG. 11 C is a perspective view of a shift bar that is pivotally mounted to a portion of the first pawl of FIG. 11A.

FIG. 12A is a right side perspective view of one embodiment of the second pawl of the present invention.

FIG. 12B is a left side perspective view of the second pawl of FIG. 12A.

FIG. 13A is partial side elevational view of the shifter of FIG. 1A, to show operation thereof, the first and second shifting levers positioned in a neutral position and both the first and second pawls in operative biased engagement with the respective first and second sets of teeth.

FIG. 13B is partial side elevational view of the shifter of FIG. 1A, to show operation thereof, the first and second shifting levers being moved downwardly by the rider's thumb such that the first pawl forces the gear to rotate in a first direction as the first lever is rotated

FIG. 13C is partial side elevational view of the shifter of FIG. 1A, to show operation thereof, the first and second shifting levers being biased back to the neutral position as the first shifting lever is released and both the first and second pawls in operative biased engagement with respective portions of the first and second sets of teeth.

FIG. 14A is partial side elevational view of the shifter of FIG. 1A, to show operation thereof, the first and second shifting levers positioned in a neutral position and both the first and second pawls in operative biased engagement with the respective first and second sets of teeth.

FIG. 14B is partial side elevational view of the shifter of FIG. 1A, to show operation thereof, the second shifting lever being moved downwardly by the rider's thumb such that an escapement portion of the second pawl is rotated into contact with a portion of the second set of teeth, subsequently, the first pawl is pushed away from engagement with the first set of teeth and a tooth engaging member of the second pawl is rotated out of engagement with the second set of teeth and the gear is allowed to unwind in a second direction until the escapement portion engages a tooth of the second set of teeth to effect a single shift stage reduction.

FIG. 14C is partial side elevational view of the shifter of FIG. 1A, to show operation thereof, the second lever being biased back to the neutral position as the second lever is released and showing both the first and second pawls in operative biased engagement with respective portions of the first and second sets of teeth.

FIG. 15 is a perspective view of a shifter of the present invention mounted thereto a cow-horn type of handlebar, showing a fall-finger wrap of the rider's hand on the handlebar with the distal ends of the shifting levers in ergonomic position to be operated by the rider's thumb, and showing a brake lever mounted to a distal end of the handlebar.

FIG. 16 is a perspective view of the shifter of FIG. 15, showing the rider's thumb engaging the levers of the shifter while maintaining a full-finger wrap on the handlebar.

FIG. 17 is a perspective view of the shifter of the present invention mounted thereto an aero-bar type of handlebar, showing the rider engaging the levers of the shifter while maintaining a full-finger wrap on the handlebar, showing a fall-finger wrap of the rider's hand on the handlebar with the distal ends of the shifting levers in ergonomic position to be operated by the rider's thumb.

### DETAILED DESCRIPTION OF THE INVENTION

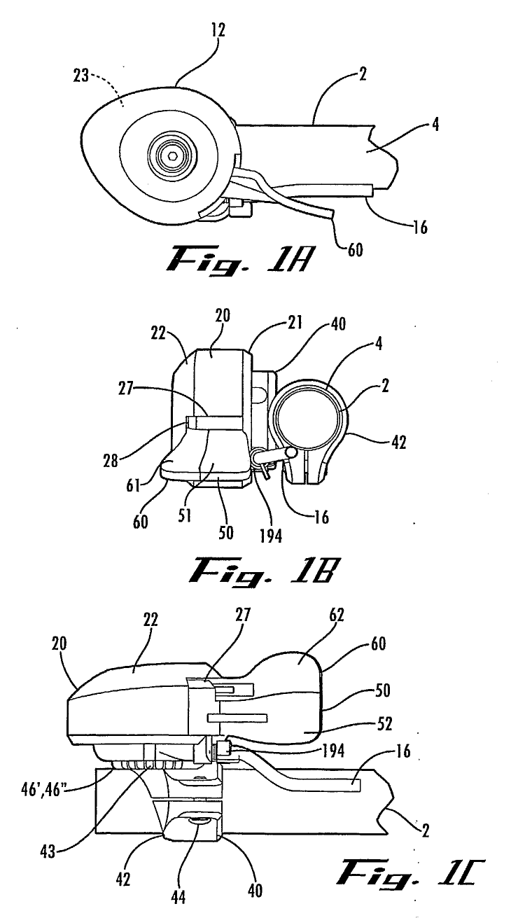

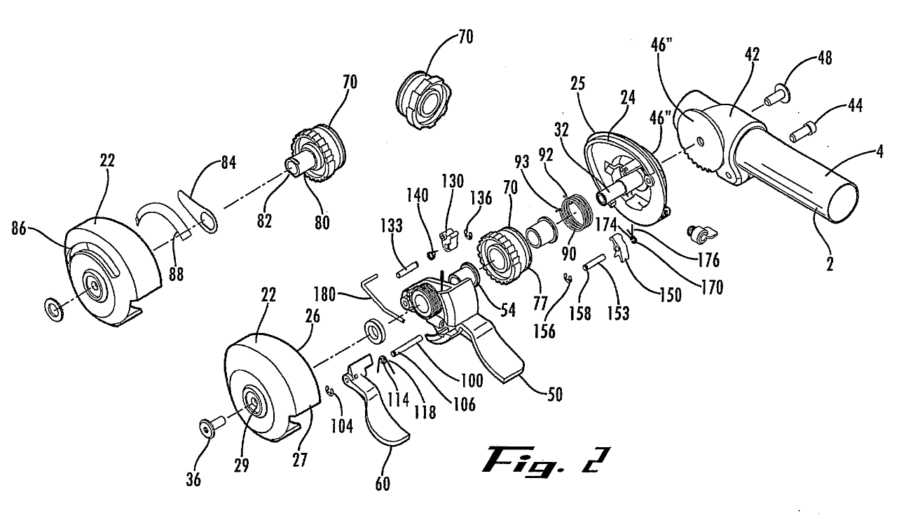

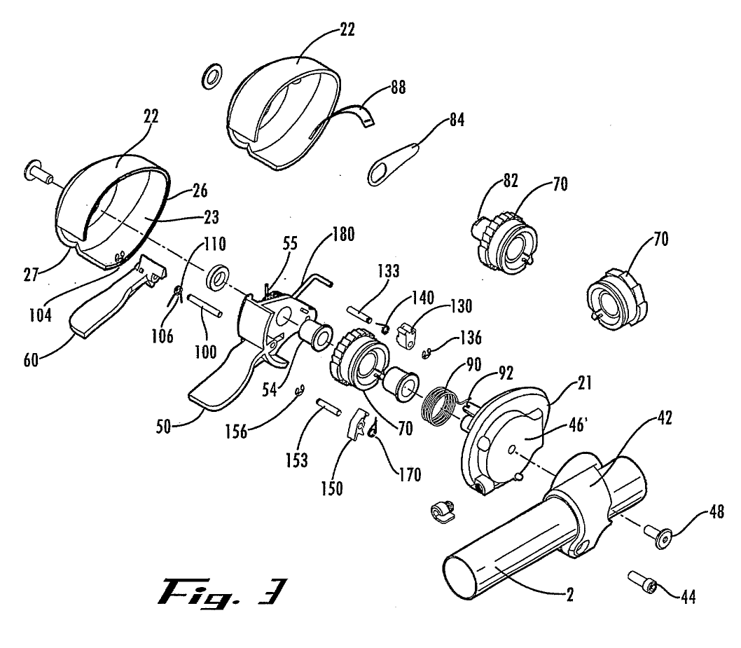

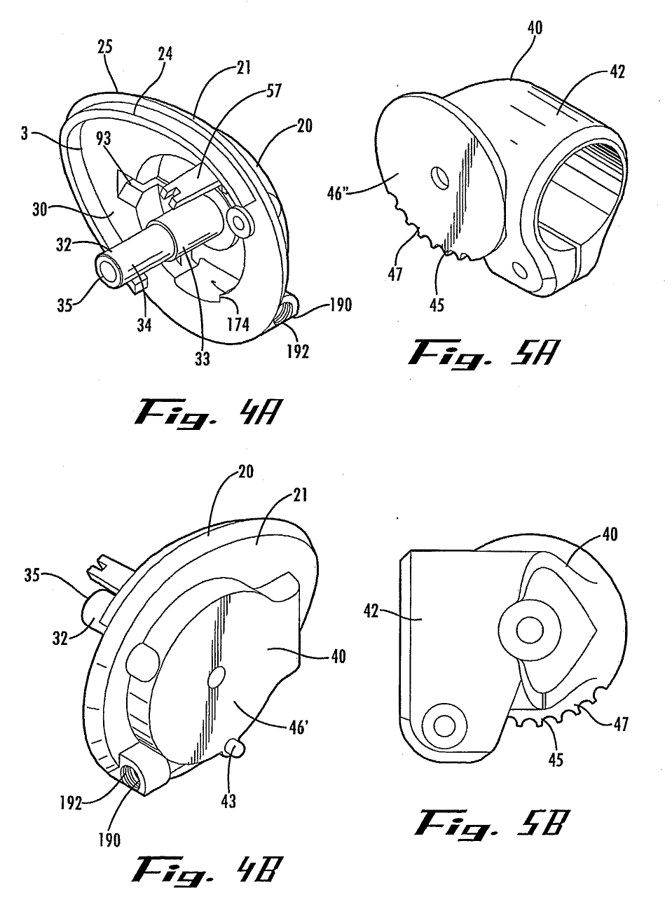

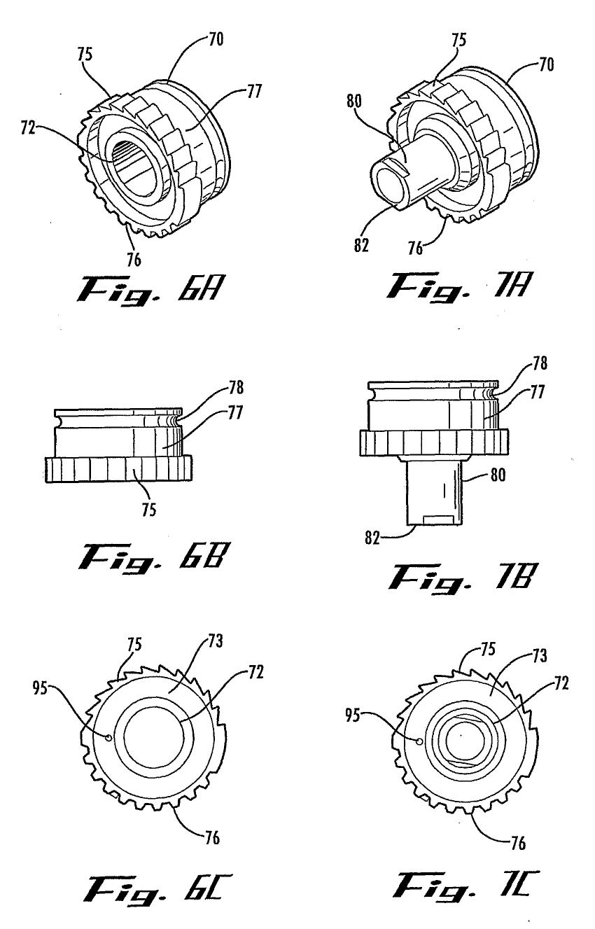

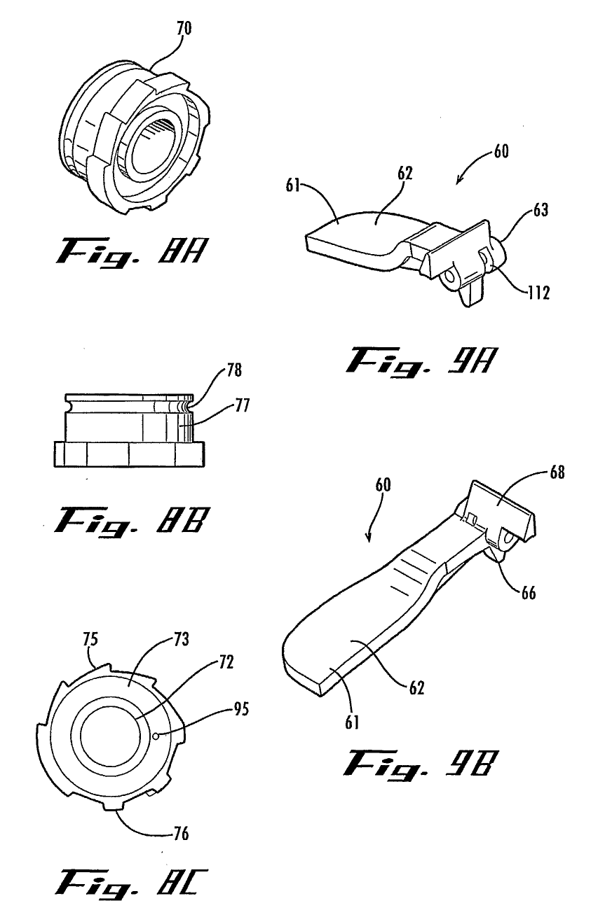

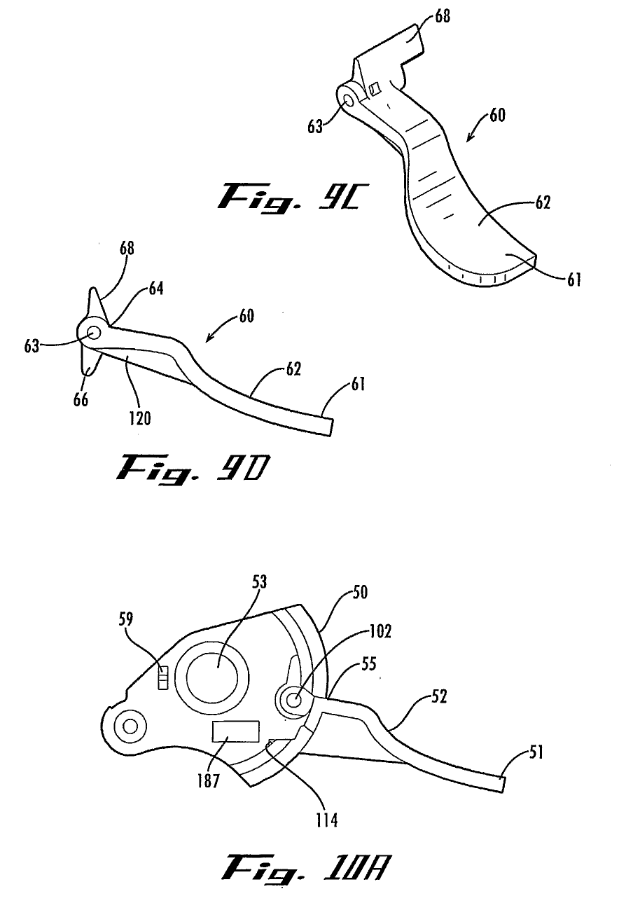

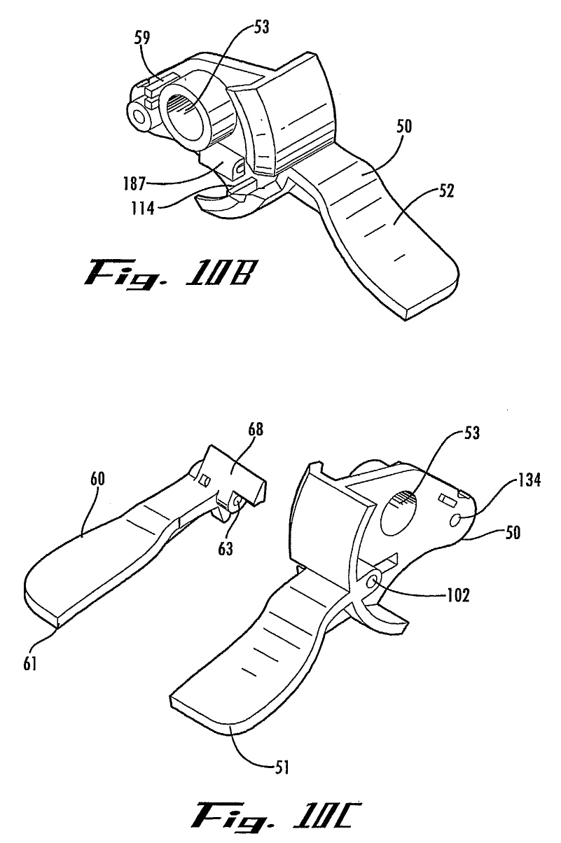

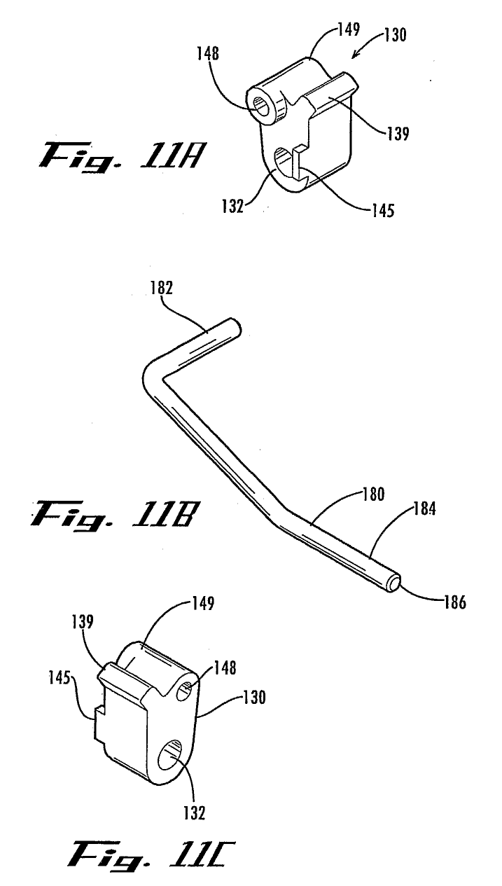

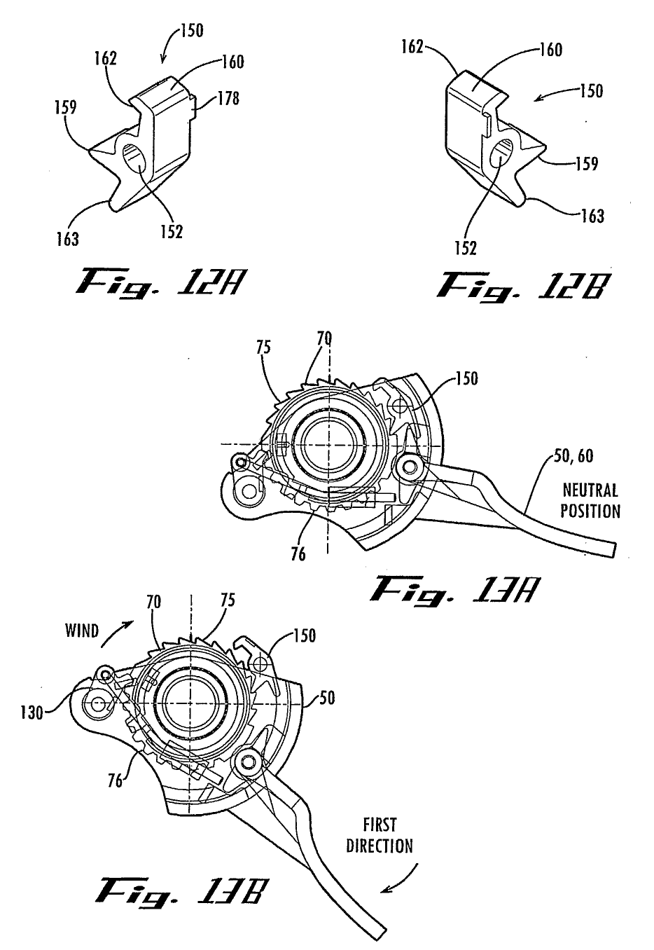

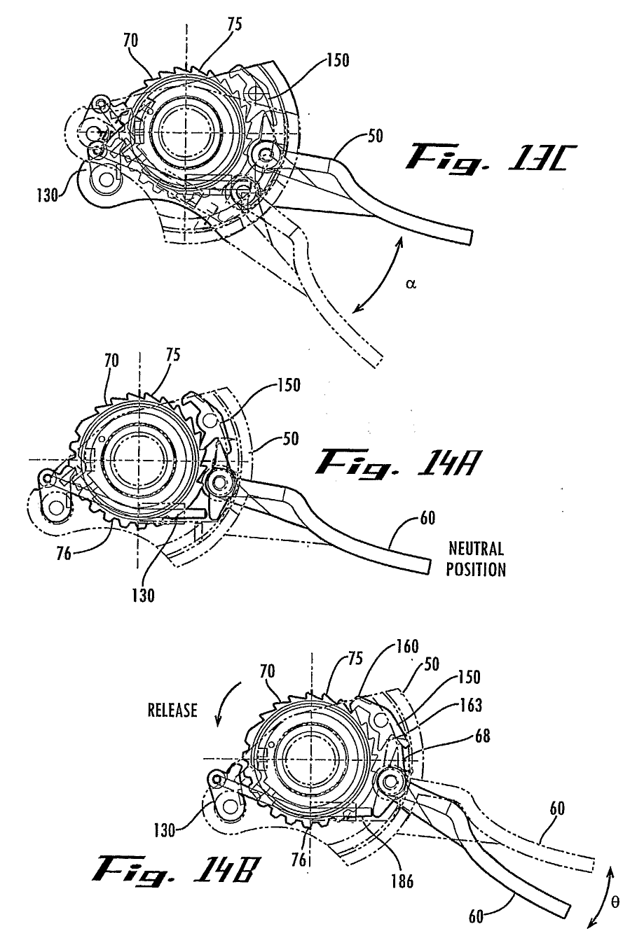

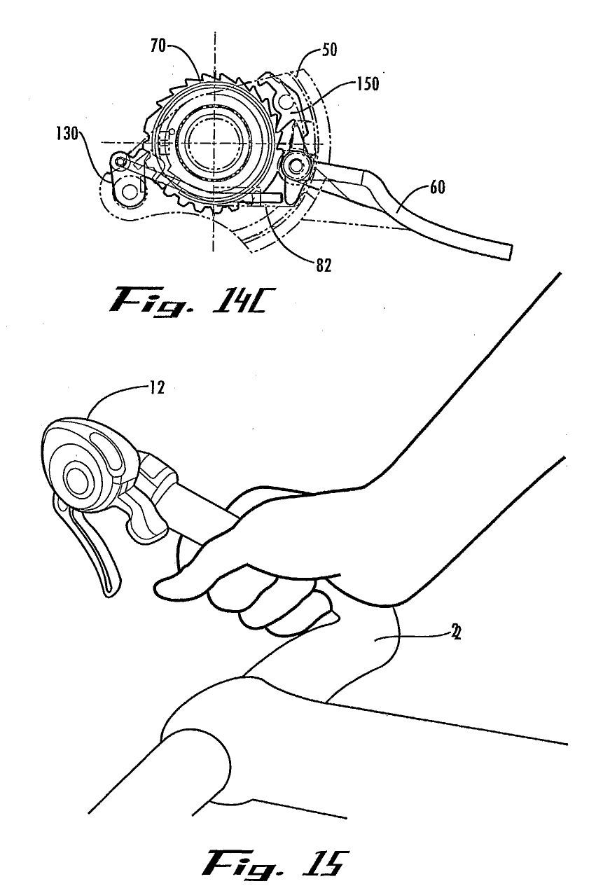

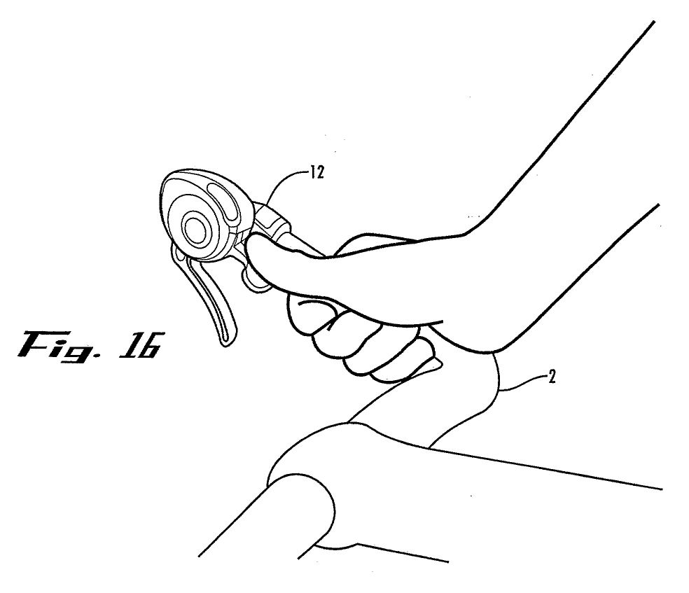

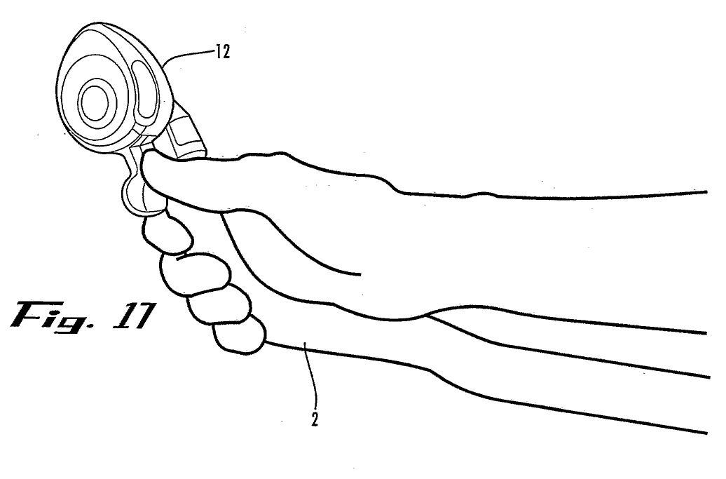

The present invention may be understood more readily by reference to the following detailed description of preferred embodiments of the invention and the examples included herein and to the figures and their previous and following description. To that end, the present invention is described in detail with reference to FIGS. 1-18 in which like numerals indicate like components throughout the several views. It is also to be understood that this invention is not limited to specific methods, specific embodiments, or to particular devices, as such may, of course, vary. It is also to be understood that the terminology used herein is for the purpose of describing particular embodiments only and is not intended to be limiting.

It must also be noted that, as used in the specification and the appended claims, the singular forms “a,” “an” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment.

In one embodiment, the present invention is directed to a conventional bicycle [not shown] having a shifter 12 coupled to a handlebar 2 of the bicycle. It is contemplated that the shifter of the present invention can be used with any type of handlebar. However, it is preferred to mount the shifter on a handlebar having a forwardly extending portion that is desired to be grasped for power efficiency, such as, for example and not meant to be limiting, cow-horn type handlebars, aero-bar type handlebars, and the like. Bicycles and their various components, such as their longitudinally extending frames, rear and/or front derailleurs, are well know in the prior art, and thus, the bicycles and their various components are not discussed or illustrated herein, except for the components that relate to the present invention.

Thus, only the shifter 12 and the components that relate thereto will be discussed and/or illustrated herein.

The shifter 12 is operatively coupled to either a front or rear derailleur via a transmission element or cable 16 to change gears in the derailleur. The shifter 12 is alternatively illustrated as a right-hand ten-stage shifting unit and a left-hand three-stage shifting unit. It will, however, be apparent to one skilled in the art from this disclosure that the shifter 12 can be constructed will any number of desired stages, e.g., a 2, 3, 4, 5, 6, 7, 8, 9, 11, 12, etc. shifter. In one aspect, the shifter 12 of the present invention can shift up and down one stage at a time. In another aspect, the shifter of the present invention is adapted to shift up or down at least one stage at a time.

Referring now to FIGS. 1A-12B, the shifter of the present invention comprises a housing 20, a wind mechanism, a release mechanism, a first shifting lever 50, and a second shifting lever 60. The housing 20 is adapted to mount to a handlebar at a desired position on the handlebar of the bicycle. In one aspect, described in more detail below, the housing can be clamped to an exterior surface 4 of the handlebar 2 via a mounting member 40 to secure the shifter 12 into position. In another aspect, the housing can have a surface that forms a mounting member [not shown], which is adapted to be inserted within the bore of the handlebar at its distal end. For example, if a cow-horn type handle bar is used, the housing of the shifter 12 can have a male protrusion portion that is sized and shaped for a complementary fit within the open distal end of the forwardly extending cow-horn type handlebar.

As shown in FIGS. 1B, 1C, 4B and 5A, in one aspect, the mounting member 40 can comprise a band clamp 42 that is fixedly connected to a portion of the exterior surface 21 of the housing 20. A band fastener 44 is provided that is adapted to releaseably tighten the band clamp to form a secure friction fit between the band clamp and the exterior surface of the handlebar. In a farther aspect, the mounting member 40 can include a pair of opposed complementary surfaces 46 that are adapted such that the housing can be rotated relative to the band clamp 42. This allows the housing 20 to be positioned in a desired relationship with the handlebar 4. In this aspect, a substantially planar portion of the exterior surface of the housing includes a male protrusion 43 extending outwardly therefrom and forms one surface 46′ of the pair of opposed complementary surfaces and a substantially planar surface integrally connected to the band clamp 42 forms the second surface 46″ of the pair of opposed complementary surfaces. A peripheral edge of the second surface has a scalloped edge portion 45 that has defined notches 47 that are sized and shaped to complementarily accept the male protrusion 43 of the surface 46′ of the housing. Further, a mounting member fastener 48 is provided so that the surfaces 46′, 46″ can be brought into contact with each other to fixedly connect the pair of opposed complementary surfaces such that the housing 20 is fixed in spatial relationship to the band clamp 42. Exemplarily, the band clamp and fasteners are constructed of a metal material, carbon fiber, and the like.

As seen in the figures, the housing 20 covers the wind and release mechanisms as well as portions of the first shifting lever 50 and the second shifting lever 60. The housing can be exemplarily formed from a substantially rigid polymer, metal, and the like and is connected to the mounting member as described above. In one aspect, the housing comprises a lower housing 21 and an upper housing 22. In one aspect, a portion of the exterior surface of the lower housing is connected to the band clamp 42. In another aspect, a portion of the exterior surface of the lower housing forms the surface 46′ of the pair of opposed complementary shaped surfaces.

As one will appreciate, the upper and lower housings 21, 22 are adapted to be assembled together in abutting relationship to define a hollow cavity 23 therebetween. In one aspect, the lower housing 21 has a flange 24 extending partially about a portion of the periphery of the lower housing. The flange 24 is spaced from the peripheral edge 25 of the lower housing such that, in use, the edge 26 of the upper housing 22 is positioned therebetween the flange and peripheral edge of the lower housing. This allows for the upper and lower housings 21, 22 to seat together in a complementary and fixed relationship to each other.

The housing 20 further defines a rearwardly facing slot 27 in the rear portion 28 of the housing 21 that it in communication with the cavity 23 of the housing. The slot 27 is sized and shaped to allow for the movement of the respective first and second shifting levers along predetermined arcuate paths about and between a neutral position, in which no external force is being applied to the respective shifting levers 50, 60, and an actuated position, in which a external force via the rider's thumb is applied to the respective shifting levers to rotate the shifting levers about their respective axis of rotation. In a further aspect, the slot 27 is sized and shaped to allow for simultaneous rotation of both the first and second shifting levers 50, 60 between the neutral position and the actuated position.

In another aspect, when the shifter 12 is positioned on the handlebar, portions of the respective distal ends 51, 61 of the handles 52, 62 of the first and second shifting levers extend rearwardly toward the rider. In one aspect, the desired hand position on the handlebar for the type of handlebar is intermediate the shifter 12 and the rider. In another preferred aspect, the desired hand position is adjacent to, and rearwardly of, the mounted shifter 12. In another aspect, the respective distal ends 51, 61 of the handles of the first and second shifting levers 50, 60 extend rearwardly substantially parallel to the adjacent portion of the handlebar. In one example, the respective distal ends of the handles of the first and second shifting levers extend rearwardly substantially parallel to the longitudinal axis of the frame of the bicycle.

The lower housing 21 defines a female depression 30 and has a transverse axle member 32 extending outwardly from the female depression. In one aspect, the axle member 32 forms a step shaped shaft with a first cylindrical mount portion 33 adjacent to the base of the axle member, a second cylindrical mount portion 34, and a threaded free end 35. The second cylindrical mount portion has a diameter that is less than the diameter of the first cylindrical mount portion. In a further aspect, the threaded free end of the axle member is adapted to operatively receive a fastener 36.

Further, the free end is adapted to abut a portion of the upper housing 22 that defines an aperture 29 sized to receive the fastener 36. Thus, in use, the fastener 36 secures the upper housing 22 to the free end 35 of the axle member 32 and resultantly, secures the upper and lower housings 21, 22 together in complementary abutting relationship.

In one aspect, a gear 70 that defines a central bore 72 is mounted thereon the first cylindrical mount portion 33 of the axle member 32 within the cavity 23 of the housing. The gear 70 further defines an interior cavity 73 and is adapted to rotate about a rotational axis defined by the longitudinal axis of the axle member. As one will appreciate, in another aspect, a bearing 74, sized and shaped for complementary fit therein the central bore 72 of the gear, may be provided to allow for non-binding movement of the gear with respect to the first cylindrical mount portion 33 of the axle member.

The gear 70 further comprises a first set of peripherally spaced teeth 75, a second set of peripherally spaced teeth 76, and a bearing surface 77. In one aspect, the first set of peripherally spaced teeth is spaced from the second set of peripherally spaced teeth. In another aspect, the respective spacing between teeth in each respective set of teeth is substantially equal. That is, the spacing between teeth of the first set of spaced teeth is substantially uniform and the spacing between teeth of the second set of spaced teeth is substantially uniform (but not necessarily the same as the spacing between teeth of the first set of spaced teeth). In another aspect, the bearing surface 77 of the gear can have a substantially circular cross-sectional shape. Alternatively, it is contemplated that the bearing surface 77 can have a non-circular cross-sectional shape such that the cable can be wound or released a desired distance per uniform stage movement of the gear. In this aspect, the bearing surface of the gear can have an eccentric cross-sectional shape. For example, the bearing surface 77 of the gear can form a camming surface that forms at least one lobe. Still further, the gear 70 defines a slot 78 for operative receipt of a distal end of the cable.

In another aspect, the gear 70 can further comprise a gear axle member 80 that extends from a top face 79 of the gear substantially along the longitudinal axis of the axle member. The distal end 82 of the gear axle member has a keyed surface adapted to fixedly mount an elongate flag 84. In this aspect, the upper housing 22 further defines an arcuate opening 86 into which is mounted a window 88 having symbols denoting the respective gears annotated thereon. In use, as the gear 70 is rotated to a select gear, the flag 84 is also rotated and is positioned adjacent the annotated symbol to inform the rider, at a glance, as to the respective gear that is selected.

In another aspect, the shifter comprises a gear biasing member 90 that is positioned about the first cylindrical mount portion 33 of the axle member intermediate the female depression 30 and the gear 70. In a further aspect, at least a portion of the gear biasing member 90 is positioned therein the interior cavity 73 of the gear. In one aspect, a proximal end 92 of the gear biasing member is mounted in a slot 93 formed in a portion of the female depression to fixedly mount the proximal end of the gear biasing member. In another aspect, the distal end 94 of the gear biasing member is inserted in a hole 95 defined in a portion of the interior cavity of the gear to fixedly mount the distal end 94 of the gear biasing member. Thus, in operation, the gear biasing member 90 is adapted to bias the gear 70 back to a neutral position.

The first shifting lever 50 defines a first lever bore 53 that further defines a rotational pivot axis of the first shifting lever. In one aspect, the first shifting lever is pivotally coupled to the second cylindrical mount portion 34 of the axle member and is movable between the neutral, released, position and the actuated position. In this aspect, the rotational pivot axis of the first shifting lever 50 is co-axial to the longitudinal axis of the axle member. In use, the distal end 51 of the handle of the first shifting lever is adapted to be engaged by the thumb of the rider to effect the rotation of the first shifting lever. As one will appreciate, in another aspect, a bearing 54, sized and shaped for complementary fit therein the first lever bore 53 of the first shifting lever, may be provided to allow for non-binding movement of the first shifting lever with respect to the second cylindrical mount portion of the axle member.

Still further, the shifter 12 can comprise a first lever biasing member 55 mountable about the first lever bore 53 of the first shifting lever. In one example, the first lever biasing member has a proximal end 56 that is adapted to be fixedly connected to a post 57 extending therefrom the lower housing 21 and a distal end 58 that is fixedly received in a slot 59 defined therein a portion of the first shifting lever. Thus, in operation, the first lever biasing member 55 is adapted to move the first shifting lever back to its neutral position.

The second shifting lever 60 defines a second lever bore 63 that defines a first pivot axis of the second shifting lever, which is spaced from, and parallel to, the longitudinal axis of the axle member. In one aspect, the second shifting lever is rotatably coupled to a portion of the first shifting lever intermediate the first shifting lever's distal end and first lever bore. In one example, the second shifting lever 60 is rotatably coupled to a portion of the first shifting lever proximate a proximal end 55 of the handle 52 of the first shifting lever. In one aspect, the proximal end 64 of the second shifting lever that surrounds the second lever bore defines a first shoulder surface 66 and a spaced second shoulder surface 68. In one aspect the first and second shoulder surfaces are substantially opposed to each other. In a further aspect, the shifter can comprise a lever axle member 100 mountable in a bore 102 defined in the portion of the first shifting lever. The second lever bore 63 is rotatably mountable thereon the lever axle member and can be secured thereto by, for example, a clamp member 104, such as, for example and not meant to be limiting, a e-clip, adapted to engage a channel 106 formed in an end portion of the lever axle member. In use, the distal end 61 of the handle of the second shifting lever 60 is adapted to be engaged by the thumb of the rider to effect the rotation of the second shifting lever about the lever axle member.

Still further, the shifter 12 can comprise a second lever biasing member 110 mountable within a slot 112 defined in the proximal end of the second shifting member and about the lever axle member. In one example, the second lever biasing member has a proximal end 114 that is adapted to engage a wall member 116 formed on a portion of the first shifting lever and a distal end 118 that is adapted to engage a lower surface 120 of the handle of the second shifting lever. Thus, in operation, the second lever biasing member is adapted to move the second shifting lever back to its neutral position.

The shifter 12 further includes a first rotatable pawl 130, a first pawl biasing member 140, a second rotatable pawl 150, and a second pawl biasing member 170. The first pawl 130 is adapted to engage the first set of teeth of the gear 75 and is rotatably mounted to the first shifting lever proximate the proximate end of the first shifting lever. The first pawl defines a first pawl bore 132 that defines a first pawl pivot axis that is spaced from, and parallel to, the longitudinal axis of the axle member. In one aspect, the first pawl 130 is rotatably coupled to a portion of the first shifting lever 50 intermediate the first shifting lever's proximal end and first lever bore. In a further aspect, the shifter can comprise a first pawl axle member 133 mountable in a bore 134 defined in the proximal end portion of the first shifting lever. The first pawl bore 132 is rotatably mountable thereon the first pawl axle member 133 and can be secured thereto by, for example, a clamp member 136, such as, for example and not meant to be limiting, an e-clip, adapted to engage a channel 138 formed in an end portion of the first pawl axle member. In use, the first pawl 130 has a tooth engaging member 139 adapted to engage a portion of the surface of one select tooth of the first set of teeth.

Still further, the first pawl biasing member 140 is mountable about the first pawl axle member 133. In one example, the first pawl biasing member has a proximal end 142 that is adapted to engage a wall protrusion 143 extending outwardly from a portion of the first shifting lever and a distal end 144 that is adapted to engage a flange member 145 extending outwardly from an edge of the first pawl. Thus, in operation, the first pawl biasing member 140 is adapted to move the first pawl into engagement with a portion of a tooth of the first set of teeth.

The second pawl 150 is adapted to engage the second set of teeth 76 of the gear 70 and is rotatably mounted to the housing. The second pawl defines a second pawl bore 152 that defines a second pawl pivot axis that is spaced from, and parallel to, the longitudinal axis of the axle member. In one aspect, the second pawl is rotatably coupled to a portion of the housing 20 adjacent the top edge of the slot 27 in the housing. In a further aspect, the shifter 12 can comprise a second pawl axle member 153 mountable in a bore 154 defined in the portion of the lower housing. The second pawl bore 152 is rotatably mountable thereon the second pawl axle member 153 and can be secured thereto by, for example, a clamp member 156, such as an e-clip, adapted to engage a channel 158 formed in an end portion of the second pawl axle member. In use, the second pawl has a tooth engaging member 159 extending outwardly from the second pawl bore that is adapted to engage a portion of the surface of one select tooth of the second set of teeth. Further, the second pawl has an escapement portion 160 that extends outwardly from the second pawl bore that has an angled tip 162, which is adapted to engage a portion of the surface of one select tooth of the second set of teeth 76. The escapement portion 160 is angularly spaced from the tooth engaging member 159 at an angle between about 175 degrees and 90 degrees.

Still further, the second pawl biasing member 170 is mountable about the second pawl axle member 153 and is adapted to move the second pawl 150 into engagement with select portions of the second set of teeth 76. In one example, the second pawl biasing member has a proximal end 172 that is adapted to engage a wall protrusion 174 extending outwardly from a portion of the lower housing and a distal end 176 that is adapted to engage a flange member 178 extending outwardly from an edge of the second pawl.

The shifter 12 further comprises a shift bar 180 having a proximal end 182 mountable therein a bore 148 formed in an abutment 149 of the first pawl. In this aspect, the abutment 149 is spaced from the first pawl bore 132 and the tooth engaging member 139 of the first pawl. The shift bar 180 further comprises a distal end portion 184 that is positioned therein a guidance channel 187 formed in a portion of the first lever. The distal end 186 of the shift bar is positioned adjacent to the first shoulder surface 66 of the second shifting lever 60. In use, when the second shifting lever is actuated, the first shoulder surface 66 of the second shifting lever contacts the distal end 186 of the shift bar and shifts the bar laterally, which causes the proximal end 182 of the shift bar to shift laterally. As a result, the first pawl 130, in opposition to the applied force of the first pawl biasing member 140, is forced away from the first set of teeth 75.

In one aspect, the respective teeth of the first and second sets of teeth 75, 76 are arcuately shaped with respect to the respective pivot axis of the first and second pawls 130, 150. This allows the tooth engaging members of the respective first and second pawls to be rotated away from the sets of teeth without forcing the gear to initially back wind from the desired direction of movement. In another respect, one skilled in the art will appreciate that it is contemplated that the second pawl 150 may be formed from two separate elements such that the relationship between the escapement portion and the tooth engaging member is allowed to vary as necessary in the winding operation.

Referring now to FIGS. 13A-13C, in use for a shifting operation in a first direction, against the resistance of the gear biasing member, the first shifting lever is rotated from its neutral position such that the gear rotates in the first direction to wind the cable into the housing. As the first shifting lever is rotated away from the neutral position, the second set of teeth is rotated relative to the second pawl and the second pawl is biased into select engagement with a portion of a desired tooth of the second set of teeth that corresponds to a desired gear. Upon release of the first shifting lever, the first shifting lever is biased back in a direction opposite to the first direction to the neutral position under the influence of the first lever biasing member. As the first shifting lever moves toward the neutral position, the first pawl rotates relative to the first set of teeth until, as the first shifting lever reaches the neutral position, a portion of the first pawl is biased into select engagement with a portion of a desired tooth of the first set of teeth.

In one aspect, for the shifting operation in the first direction, the second lever is rotated simultaneously with the first shifting lever when the first shifting lever is rotated from the neutral position. In another aspect, the second shifting lever is rendered ineffectual upon rotation of the first shifting lever.

Referring to FIGS. 14A-14C, in use for a shifting operation in a second direction opposite to the first direction, aided by the bias force exerted by the gear biasing member, the second shifting lever is rotated from its neutral position such that the second shoulder surface of the second shifting lever contacts a flange 163 of the second pawl that is spaced from the tooth engaging member and the escapement portion of the second pawl such that the second pawl is rotated in opposition to the applied force of the second pawl biasing member. Initially, the escapement portion of the second pawl is rotated into a position such that the tip portion of the escapement portion bisects the operative envelope of the second set of teeth. Subsequently, the tooth engaging member of the second pawl is moved out of engagement with the second set of teeth. Finally, the first shoulder surface of the second shifting lever contacts the distal end of the shift bar and shifts the bar laterally, which forces the first pawl away from engagement with the first set of teeth. Thus, both of the respective tooth engaging members of the first and second pawls are spaced from the surfaces of the respective first and second sets of teeth. This allows the gear to rotate for one shift stage in the second direction under the influence of the gear biasing member, which allows the cable to be released from the housing. The escapement portion of the second pawl engages a tooth of the second set of teeth and restricts the movement of the gear to one shift stage per actuation of the second shifting lever. Upon release of the second shifting lever, the second shifting lever is biased back to the neutral position such that both of the respective tooth engaging members of the first and second pawls are allowed to be rotated into engagement with respective portion of the first and second sets of teeth. When both of the tooth engaging members are in operative contact with the respective first and second sets of teeth, the escapement portion of the second pawl is rotated away from engagement with the select tooth of the second set of teeth and, subsequently, the tooth engaging members of the first and second pawls rotate and drop into engagement with select gear teeth of the respective first and second sets of teeth as the gear continues to rotate to its stage end position.

In a further aspect, ergonomically, the shifter provides an arcuate path of the first shifting lever that subtends an angle γ in a movement plane of less than about 40 degrees with respect to the housing. In an alternative embodiment, the angle γ is less than about 30 degrees, and in a further embodiment, the angle γ is less than about 25 degrees. In this aspect, the movement plane is substantially parallel to a line bisecting the handlebar on which the shifter is mounted.

In another aspect, the second shifting lever is adapted to move along a predetermined arcuate path that subtends an angle θ of less than about 30 degrees relative to the first shifting lever. In an alternative embodiment, the angle θ is less than about 25 degrees, and in a further embodiment, the angle θ is less than about 20 degrees. In this aspect, the second predetermined arcuate path of the second shifting lever is substantially parallel to the movement plane.

It is farther contemplated that the housing 20 of the shifter 12 defines a passage 190 adapted to allow for the passage of the cable. In this aspect, a proximal end of the passage underlies a portion of the bearing surface 77 of the gear 70. In a further aspect, the passage extends substantially rearwardly such that a distal end 192 of the passage is defined in the rear portion 28 of the housing. The distal end of the passage is threaded to accept a cable adjustment assembly 194 that is adapted to grasp a portion of the cable 16 to allow for tensioning of the cable. In use, the cable 16 exits the cable adjustment assembly 194 proximate to the shifting levers 50, 60, but spaced from the movement planes of the first and second shifting members. The cable 16 is then routed along or through the adjacent handlebar 2 thereby providing an aesthetic and visually appealing design.

It is further contemplated that the shifter can further comprise a brake subassembly pivotally mounted to a forward portion of the housing. The brake assembly is conventional and comprises a brake lever that is connected to a brake cable and is spaced from the first and second shifting levers of the shifter.

It is further contemplated that one shifter could be mounted to an aero-bar handlebar and an identical or substantially similar shifter could be mounted to a cow-horn handlebar. The two shifters mounted on the bicycle can be provided with means for interconnecting the shifters such that a shift inputted at either of the shifters would be simultaneously made at the other shifter.

In one aspect, the housing of the shifter is mounted to the handlebar so as to position the first and second shifting levers relative to the handlebar such that the distal ends of the handles of the respective first and second shifting levers are positioned intermediate the handlebar and the longitudinal axis of the bicycle. In this position, the first and second shifting levers are adapted to pivot with the thumb of the person during a shifting operation with a person holding onto the handlebar, whereby a grip of the person is tightened on the handlebar on which the shifter is mounted.

It will be appreciated that the essence of the present invention is the movement of the shifting levers of the shifter of the present invention is in the natural movement direction of the thumb in order to maintain and/or tighten the grip of the rider during a shifting operation. It will be appreciated that the first and second shifting levers subtend a movement angle that approximates the natural movement of the thumb when the hand is holding the handlebar. Further, unlike conventional shift levers, the shifting levers according to the present invention has their respective pivot axis located very close to the knuckle of the thumb, so that the thumb can efficiently move the levers. In use, the distal ends of the handles of the first and second levers are located forward of the thumb in their neutral or actuated positions. This eliminates “reach back” of the thumb to find the shifting levers, as in other shifters. This also keeps the distal ends of the handles of the shifting levers close to the thumb when the hand is wrapped around the handlebar, as shown in FIG. 15. Of course, the same thumb is used to actuate the second shifting lever for the reverse shift operation.

Thus, with the present invention, the shifting levers provides only minimal repositioning of the hands to actuate either the first or second shifting levers, depending on the direction of the shifting operation, so that the thumb, palm, and fingers remain wrapped around the handlebar, substantially in contact therewith at all times. Further, the movement of the shifting levers coincides with the natural movement of the thumb to bring the thumb in closer to the other fingers and thereby increase the strength of the grip. In other words, the shifting allows the thumb to mimic the natural movement of the thumb. Specifically, when actuating either the first or second shifting levers, the thumb reaches forward as shown in FIG. 16, rather than back, to activate the selected shifting lever, and then pushes the shifting lever downwardly to tighten the grip. Because of the present arrangement, when the thumb is brought downwardly, there is no restriction from other components of the bicycle, such as the brake, etc.

Thus, although a specific arrangement has been provided with respect to the winding and release mechanism for effectuating the shifting operation, the broad aspect of the present invention is intended to cover any shifting arrangement which uses a shifter in which the shifting levers are actuated by the thumb of a person to move in a direction corresponding to the natural thumb movement in order to tighten the grip on the handlebar. Thus, the movement of either the first and second shifting levers complements the natural motion of the thumb to close the grip around the handlebar. With the present invention, the palm of the hand stays on the bar because the thumb does not have to reach back for the shifting levers, thereby retaining the integrity and safety of the closed hand grip on the handlebar. Thus, the closed hand on the handlebar allows operation of the select shifting lever while maintaining the hand fully wrapped around the handlebar as in a normal riding position. This complements an aggressive riding hand position, as in racing where a tight grip is essential. A fully closed hand on the handlebar means less effort to hold onto the handlebar and a stronger connection to the handlebar. Further, no bending of the wrists is required, such as required with conventional twist grip shifters, which further offers better control in riding conditions.

Further, repositioning of the hand is not required for activation of the second shifting lever since the second shifting lever is mounted adjacent to the first shifting lever for return shifting. The index finger is not used to shift at all. Thus, the strongest finger is used for gripping and is not used at all for shifting, which would otherwise open the curl of the hand and reduce the integrity of the grip. Therefore, all fingers remain curled around the handlebar during shifting to maintain a secure grip. This also leaves the index finger as a dedicated finger for performing a braking operation and for gripping the handlebar, because it is not needed for shifting, unlike conventional shift levers. This is important because the index finger opposes the thumb for tightening the grip. Further, with the present invention, more room is allowed for the fingers to wrap around the handlebar because there are no levers in the way of the fingers/grip.

It should be understood that the arrangement or architecture of the illustrated device and system are exemplary, and others will occur readily to persons skilled in the art in view of the teachings in this patent specification. In other embodiments, the system can have more or fewer elements. Furthermore, it should be understood that the functions of elements can be separated, combined, or otherwise distributed over a group of elements in a manner different from that described in this exemplary embodiment of the invention.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein.

What is claimed is:

1. A shifter for mounting to a handlebar of a bicycle having a frame extending along a longitudinal axis, comprising:
a housing defining a cavity therein, wherein the housing is adapted to mount to a handlebar of the bicycle;
a gear rotatably mounted in the cavity of the housing about a rotational axis and comprising a first set of peripherally spaced teeth, a second set of peripherally spaced teeth in spaced relation to the first set of teeth, and a bearing surface for securing a biased cable;
a gear biasing member mounted to a portion of the housing and a portion of the gear for biasing the gear back to a neutral position;
a first shifting lever rotatably mounted to the housing for rotation about the rotational axis, the first shifting lever having a handle having a distal end adapted to be engaged by a thumb of a person to effect the rotation of the first shifting lever;
a second shifting lever rotatably mounted to the first lever for rotation about a first pivot axis, the second shifting lever having a handle having a distal end adapted to be engaged by the thumb of the person to effect the rotation of the second shifting lever;
a first rotatable pawl for engaging the first set of teeth, the first pawl element being mounted to the first shifting lever and being rotatable about a first pawl pivot axis;
a first pawl biasing member for biasing the first pawl element into engagement with the first set of teeth; and
a second rotatable pawl rotatably mounted at a second pawl pivot axis for engaging the second set of teeth, the second pawl element being rotatably mounted to the housing;
a second pawl biasing member for biasing the second pawl element into engagement with the second set of teeth;
wherein, in use, for a shifting operation in a first direction, the first shifting lever is rotated from a neutral position such that the gear rotates in a first direction to wind the cable into the housing and the second set of teeth is rotated relative to the second pawl, wherein the second pawl is biased into select engagement with a portion of a desired tooth of the second set of teeth, wherein, for a shifting operation in a second direction, the second shifting lever is rotated from a neutral position such that the first pawl is separated from the first set of teeth and at least a portion of the second pawl is separated from the second set of teeth such that the gear spring rotates the gear is a second direction back toward the neutral position of the gear, whereby the cable is released from the housing.

2. The shift lever of claim 1, wherein portions of each of the respective distal ends of the handles of the first and second shifting levers extend rearwardly substantially parallel to the adjacent portion of the handlebar.

3. The shift lever of claim 1, wherein portions of each of the respective distal ends of the handles of the first and second shifting levers extend rearwardly substantially parallel to the longitudinal axis of the frame of the bicycle.

4. The shift lever of claim 1, wherein the housing defines a passage adapted to allow for the passage of the cable, wherein a proximal end of the passage underlies a portion of the bearing surface of the gear, and wherein the passage extends substantially rearwardly such that a distal end of the passage is defined in a rear portion of the housing.

5. The shifter of claim 4, wherein the housing defines a slot in the rear portion of the housing that is in communication with the cavity of the housing, and wherein the slot is sized and shaped to allow for rotation of the first shifting lever along a predetermined arcuate path about and between the neutral position and an actuated position.

6. The shifter of claim 5, wherein the slot is sized and shaped to allow for simultaneous rotation of both the first and second shifting levers between the neutral position and the actuated position.

7. The shifter of claim 6, wherein, for the shifting operation in the first direction, the second lever is rotated simultaneously with the first shifting lever when the first shifting lever is rotated from the neutral position, and wherein the second shifting lever is rendered ineffectual upon rotation of the first shifting lever.

8. The shifter of claim 1, farther comprising a first lever biasing member for biasing the first shifting lever back to the neutral position.

9. The shifter of claim 8, wherein, for the shifting operation in the first direction, upon release of the first shifting lever, the first shifting lever is biased back is a direction opposite to the first direction to the neutral position such that a portion of the first pawl rotates relative to the first set of teeth until a portion of the first pawl is biased into select engagement with a portion of a desired tooth of the first set of teeth.

10. The shifter of claim 1, further comprising a second lever biasing member for biasing the second shifting lever back to the neutral position.

11. The shifter of claim 10, wherein, for a shifting operation in the second direction, upon release of the second shifting lever, the second shifting lever is biased back to the neutral position such that both of the respective first and second pawls are allowed to be rotated into engagement with respective portions of the first and second sets of teeth.

12. The shifter of claim 1, wherein the arcuate path of the first shifting lever subtends an angle in a movement plane of less than about 40 degrees with respect to the housing, and wherein the movement plane is substantially parallel to a line bisecting the handlebar on which the shifter is mounted.

13. The shifter of claim 12, wherein the second shifting lever is adapted to move along a second predetermined arcuate path, wherein the second predetermined path subtends an angle of less than about 30 degrees relative to the first shifting lever, and wherein the second predetermined arcuate path of the second shifting lever is substantially parallel to the movement plane.

14. The shifter of claim 1, wherein the bearing surface of the gear has a non-circular cross-sectional shape.

15. The shifter of claim 14, wherein the bearing surface of the gear is a camming surface forming at least one lobe.

16. The shifter of claim 14, wherein the bearing surface of the gear has an eccentric cross-sectional shape.

17. The shifter of claim 1, further comprising a mounting member adapted to be coupled to a portion of the handlebar of the bicycle, wherein the mounting member is connected to a portion of the housing.

18. The shifter of claim 17, further comprising means for releasably connected the housing to the mounting member such that the housing can mounted such that the first and second shifting levers are positioned at a desired position relative to the handlebar.

19. The shifter of claim 1, further comprising a brake subassembly rotatably mounted to a portion of the housing, the brake assembly comprising a brake lever that is connected to a brake cable and is spaced from the first and second shifting levers.

20. The shifter of claim 1, wherein the housing is mounted to the handlebar so as to position the first and second shifting levers relative to the handlebar such that the distal ends of the respective first and second shifting levers are positioned intermediate the handlebar and the longitudinal axis of the bicycle, and wherein the first and second shifting levers are adapted to pivot with the thumb of the person during a shifting operation with a person holding onto the handlebar, whereby a grip of the person is tightened on the handlebar on which the shifter is mounted.

21. A ergonomic shifter for a bicycle having a drive train and a longitudinal axis, comprising:
a housing including a mounting member for mounting the housing on a handlebar of the bicycle at a remote location from the drive train, the housing having a cavity therein;
a gear assembly in the housing for controlling actuation of the drive train;
a first shifting lever mounted to the housing for rotation relative to the housing, the first shifting lever having a distal end adapted to be engaged by a thumb of a person to effect the rotation of the first shifting lever, wherein the first shifting lever is operatively coupled with the gear assembly to activate the gear assembly to control actuation of the drive train in a first direction; and
a second shifting lever mounted to the first shifting lever for rotation relative to the first shifting lever, the second shifting lever having a distal end adapted to be engaged by a thumb of a person to effect the rotation of the second shifting lever, wherein the second shifting lever is operatively coupled with the gear assembly to activate the gear assembly to control actuation of the drive train in a second direction;
wherein the housing is mounted to the handlebar so as to position the first and second shifting levers relative to the handlebar such that the distal ends of the respective first and second shifting levers are positioned intermediate the handlebar and the longitudinal axis of the bicycle, wherein the first and second shifting levers are adapted to pivot with the thumb of the person during a shifting operation with a person holding onto the handlebar, whereby a grip of the person is tightened on the handlebar on which the shifter is mounted, wherein the first shifting lever moves along a first actuate path that subtend an angle in a movement plane of less than about 40 degrees with respect to the housing, wherein the second shifting lever moves along a second actuate path that subtends an angle parallel to the movement plane of less than about 30 degrees relative to the first shifting lever, and wherein the movement plane is substantially parallel to a line bisecting the handlebar on which the shifter is mounted.

22. The shifter of claim 21, wherein the handlebar is a cow-horn handlebar.

23. The shifter of claim 21, wherein the handlebar is an aero-bar handlebar.
